(19) United States
(12) Patent Application Publication
(10) Pub. No.: US 2018/0131225 A1
(43) Pub. Date: May 10, 2018

(54) MOBILE DEVICE WITH INTEGRATED SOLAR CHARGING APPARATUS

(71) Applicant: Mitchell Greene, Brooklyn, NY (US)

(72) Inventor: Mitchell Greene, Brooklyn, NY (US)

(21) Appl. No.: 15/344,546

(22) Filed: Nov. 6, 2016

(51) Int. Cl. H02J 7/35; H02S 40/38; H02J 7/00

(52) U.S. Cl. CPC H02J 7/355; H02J 7/0044; H02S 40/38

(57) ABSTRACT

A solar powered electronic device, comprising a housing body a battery module disposed in said housing body and a solar module configured on said housing for providing a power to said battery module, wherein the solar module receives the light from a light source and covert said light into said power and transmit said power to said battery module.

### BACKGROUND OF THE INVENTION

The invention relates to a portable electronic device, and more particularly to a portable electronic device with a solar cell for charging purposes.

The use of mobile communication devices or mobile devices, such as PDAs, cell phones (smart phones, or mobile phones), tablets, and laptop computers, is well known. It is understood that such devices must be supplied with electricity to power their operations. Consequently, rechargeable batteries are typically utilized to enable the provisions of electrical power while not substantially compromising the mobile aspect of such mobile devices. However, many times users are not always near a power source or have an external battery in the event that their device loses power.

The use of solar power is well known, and the current use of solar power has become increasing more common. Utilization of solar panels for home and office has proven successful in generating adequate power from absorbing light and converting it into energy. Since the creation of solar panels, there has been a great increase in efficiency of the solar panels and also a decrease in the size requirements for the solar panels to operate efficiently.

With the low power consumption of mobile devices and the ability to produce an efficient solar panel. There is a need of a mobile device with an integrated solar cell that works with artificial or natural light sources.

### SUMMARY

The object of the present invention to overcome the deficiencies of the prior art and to provide a system and device for providing a power supply in both indoor and outdoor conditions by suing solar panels. As such, the general purpose of the present invention, which will be described subsequently in greater detail, is to provide a new and improved device that receives the light from a light source to charge the chargeable battery source of a portable electronic device, which has all the advantages of the prior art and none of the disadvantages.

An object of the invention is to provide a portable electronic device with solar panels that works in both indoor and outdoor conditions. An exemplary embodiment of such a portable electronic device comprises a housing, a plurality of electronic components disposed in the housing, a battery module disposed in the housing, a solar module that works with artificial lights or natural lights. The solar module provides a supplied power to the battery module. The solar module receives the light from a light source to charge the chargeable battery source.

### BRIEF DESCRIPTION OF THE DRAWINGS

FIG. 1 depicts a front view of a mobile device, in accordance with an embodiment of the present invention;

FIG. 2 depicts a rear view of a mobile device, in accordance with an embodiment of the present invention; and

FIG. 3 depicts a block diagram of the components of a mobile device, in accordance with an embodiment of the present invention.

### DETAILED DESCRIPTION OF THE INVENTION

Embodiments of the present invention discloses a mobile device with an integrated solar cell for purposes of providing constant power to the integrated battery or to provide direct power.

Solar cells (or panels) are relatively underutilized in the mobile device industry. The vast majority of people have at least one mobile device, and with the increased need of energy to power the increasing demand of the mobile devices a method of constantly charging the mobile device is required. This invention provides an apparatus that incorporates a solar cell with the mobile device to provide substantially constant power source, or a substantially constant charging means for the integrated battery.

The present invention will now be described in detail with reference to the Figures.

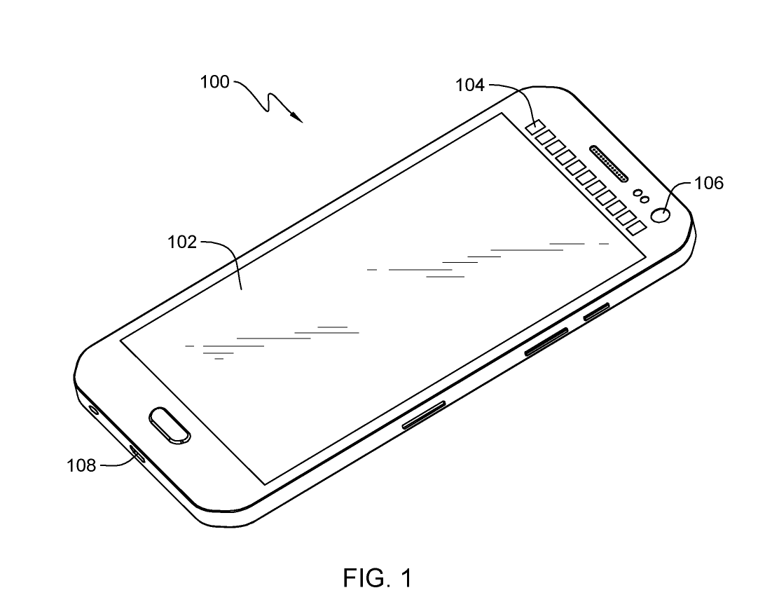

FIG. 1 depicts a front view of a mobile device 100, in accordance with an embodiment of the present invention. In the shown embodiment, the mobile device 100 has a touch screen 102, solar cells 104, and a front facing camera 106 and a charging port 108. In the shown embodiment, the mobile device 100 is a typical touch screen smart phone. In additional embodiments, mobile device 100 can be a tablet, laptop, a palm computer, a cellular phone, or other hand held devices that are electronic. In some embodiments, the mobile device 100 includes a processor, a storage device (such as a hard drive, flash memory, communication with an internet storage server, and solid-state media), a speaker, a memory card slot 6 and SIM card slots and a microphone, or the like.

In additional embodiments, the mobile device 100 has an antenna (not shown) is included for two-way communication. The antenna can be either an internal antenna, located within the mobile device 100, or the antenna can be an external antenna that is connected to the outside of the mobile device 100. In additional embodiments, the mobile device 100 is waterproof and shockproof.

In one embodiment, the mobile device 100 is defined by a case (not shown) which is configured to be removable attached through the operation of a plurality of fasteners to each other to form an enclosure in which a mobile device 100 is placed and secured. The solar cells 104 are integrated into the case and generate electrical energy which is then transferred to the mobile device 100 through charging port 108.

In the shown embodiment the touch screen 102 is separated from the solar cells 104. In some embodiments, the touch screen 102 material can be integrated with the solar cells 104 to create one screen. The touch screen 102 is used to interact with the mobile device's 100 features and is use as a display like most typical mobile devices.

The solar cells 104 can be, but are not limited to monocrystalline cells, polycrystalline silicon solar cells, thin-film solar cells, string ribbon solar cells, amorphous silicon solar cells, cadmium terruirde solar cells, polymer solar cells, luminescent solar cells, a hybrid solar cell, photovoltaic solar cell, or the like. In additional embodiments, the solar cell 104 is made from at least one of various materials such as silicon (Si), gallium arsenide (GaAs), cadmium supplied (CODS), indium phosphide (In) and combinations thereof. In the shown embodiment, the solar cells 104 are located above the touch screen 102. In other embodiments, the solar cells 104 can be places around, above, below, or integrated into the touch screen 102 provided they do not interfere with the front facing camera 106 and any additional features of the mobile device 100. The solar cells 104 are adapted to work with artificial light or natural light. In the shown embodiment, a plurality of solar cells 104 are disposed on the outer surface of the front side of the mobile device 100 above the touch screen 102.

The solar cells 104 are able to gather energy from natural light and/or artificial light. The solar cells 104 are configured on the mobile device 100 to charge a battery when the user walking, talking, running, working in the office, house or kitchen in the presence of artificial light or natural light. Further, the artificial light is a manmade device which is adapted to emit light, bulb light, LED light, street light, incandescent light, squiggly light, ambient light, which the solar cells 104 are able to gather energy from and charge the battery.

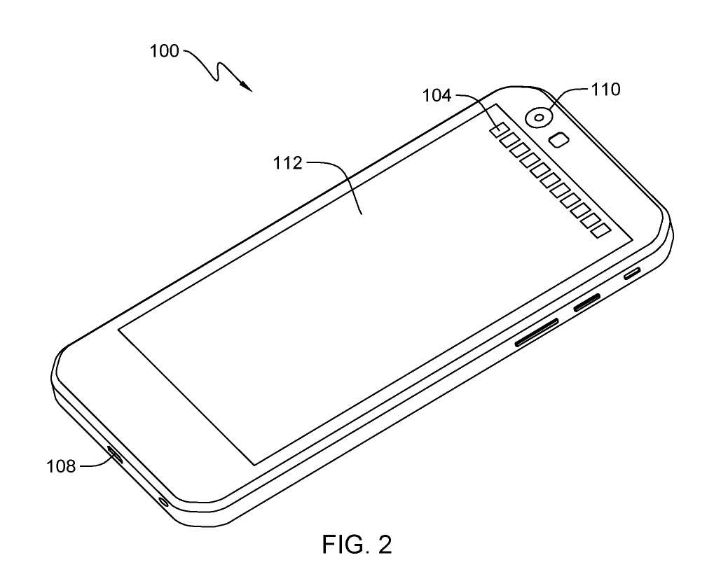

FIG. 2 depicts a rear view of the mobile device 100, in accordance with an embodiment of the present invention. The mobile device 100 has a rear camera 110, a rear side surface 112, and the power cells 104. In the shown embodiment, the power cells 104 are disposed on the rear side 112 of the mobile device 100. In further embodiments the solar cells can be integrated into the rear side surface 112 of the mobile device 100.

The rear side surface 112 can be metal, plastic, composite, glass, or a hybrid provided the solar cells 104 can either be disposed on or integrated into the rear side surface 112. In the shown embodiment, the solar cells 104 are disposed on the upper portion of the rear side surface 112. In additional embodiments, the solar cells 104 can be disposed or integrated into a larger portion or substantially all of the rear side surface 112. In additional embodiments, the solar cells 104 are disposed and/or integrated into a portion of the rear side surface that would be ergonomically pleasing to the user and provide the greatest amount of energy absorption. In additional embodiments, the solar cells 104 are located on both the touch screen 102 side of the mobile device 100 and the rear side surface 112 of the mobile device. 100.

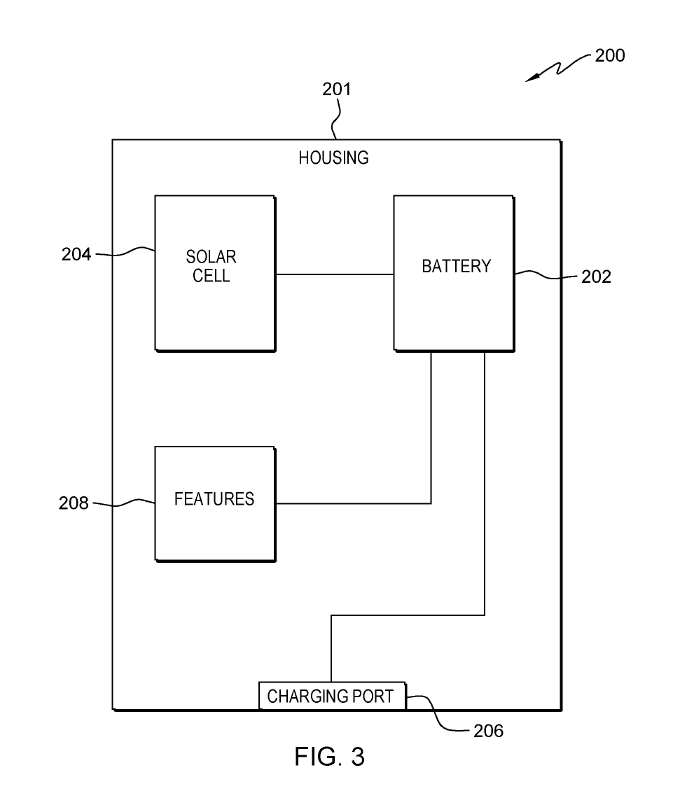

FIG. 3 depicts a block diagram of the components of a mobile device 200, in accordance with an embodiment of the present invention. The mobile device 200 has a case 201, a battery 200, a power cell 204s, a charging port 206, and features 208 of the mobile device. The features of the mobile device 208 can be, but are not limited to, cameras, flashes, displays, buttons, antennas, transponders, receivers, and the like.

In one embodiment, the case 201 of the mobile device 200 is integrated with the internal components (e.g. the battery 200, the charging port 206, and the features 208) as well as the solar cells 204. In additional embodiments, the case 201 encapsulates an electrical system, sealing the electrical system inside the case 201. In additional embodiments, the case 201 is an external case that is attached to the mobile device and also connects with the charging port 206, where the solar cells 204 are integrated or disposed on the case 201 and provide both protection for the mobile device 200 and also charge the batter 202. In additional embodiments, the solar cells 204 are integrated into the external case 201 on a plurality of surfaces to maximize exposure to light sources.

The battery 202 is used to power the mobile device 200 and all of the mobile device's 200 features 208. The battery can be, but not limited to, lithium polymer, lithium ion, nickel cadmium, nickel metal hybrid, and the like. In the shown embodiment, the battery 202 is connected electronically to the solar cell 204, the features 208, and the charging port 206. This provides the battery 202 to be charged by the solar cells 204, the charging port 206, or a combination of the two.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A solar powered electronic device, comprising:
a housing body;
a battery module disposed in said housing body; and
a solar module configured on said housing for providing a power to said battery module, wherein the solar module receives the light from a light source and covert said light into said power and transmit said power to said battery module.

2. The solar powered electronic device according to claim 1, wherein said solar powered electronic device is selected from a group of a mobile phone, PDA, tablet, smartphone, communication device and combination thereof

3. The solar powered electronic device as claimed in claim 1, wherein said solar powered electronic device is a case for securely holding said solar powered electronic device.

4. The solar powered electronic device as claimed in claim 1, wherein the solar module comprises at least one solar cell panel.

5. The solar powered electronic device as claimed in claim 1, wherein said battery module comprises a rechargeable battery.

6. The solar powered electronic device as claimed in claim 1, wherein said light source is selected from a group of an artificial light sources, natural light sources and the combination thereof.

7. A solar powered electrical device, comprising:
an enclosure;
a solar powered panel integrated into the enclosure, wherein the solar powered panel gathers energy from an external light source; and
an electrical system encapsulated inside the enclosure and connected to the solar power panel, wherein the electrical system is powered by the energy gathered by from the solar powered panel.

8. The solar powered electronic device according to claim 7, wherein said solar powered electronic device is selected from a group of a mobile phone, PDA, tablet, smartphone, communication device and combination thereof

9. The solar powered electronic device as claimed in claim 7, wherein said solar powered electronic device is a case for securely holding said solar powered electronic device.

10. The solar powered electronic device as claimed in claim 7, wherein the solar module comprises at least one solar cell panel.

11. The solar powered electronic device as claimed in claim 7, wherein said battery module comprises a rechargeable battery.

12. The solar powered electronic device as claimed in claim 7, wherein said light source is selected from a group of an artificial light sources, natural light sources and the combination thereof.
